(19) United States
(12) Patent Application Publication
(10) Pub. No.: US 2007/0293159 A1
(43) Pub. Date: Dec. 20, 2007

(54) Apparatus and method for reducing background noise

(76) Inventor: Esa Etelapera, Tampere (FI)

Correspondence Address: PERMAN & GREEN, 425 POST ROAD, FAIRFIELD, CT, 06824, US

(21) Appl. No.: 11/471,019

(22) Filed: Jun. 20, 2006

(51) Int. Cl. H04B 1/38

(52) U.S. Cl. 455/73

(57) ABSTRACT

An apparatus including an audio input module and an activation device configured to activate the audio input module when the audio input module is in a mute mode and deactivate the audio input module when the activation device is deactivated.

### BACKGROUND

1. Field

The present embodiments relate to mobile communication devices and, more particularly, to mobile telephones.

2. Brief Description of Related Developments

As today's lifestyles become more demanding, more and more people utilize mobile communication devices while traveling, eating at restaurants or while they are in an otherwise noisy environment. While the user is on, for example a telephone call, the background noise may be overwhelming for the listener or person on the other end of the call. Current mobile communication devices utilize a mute feature to help eliminate background noise while the user is not talking into the phone, however these mute features are either turned on or off. More often than not a user of the phone forgets to turn the mute feature back on after speaking or the user does not use the mute feature as it may be to bothersome to keep turning the feature on and off every time the user speaks into the phone.

It would be advantageous for a user to easily unmute and mute the mobile communication device during a communication session.

### SUMMARY

In accordance with one exemplary embodiment, an apparatus including an audio input module is provided. The apparatus also includes an activation device configured to activate the audio input module when the audio input module is in a mute mode.

In accordance with another exemplary embodiment, a method including disabling an audio input of a device is provided. The method also includes detecting at least one input on a user interface of the device, enabling the audio input of the device in response to the at least one input, detecting a deactivation of the at least one input and automatically re-disabling the audio input of the device.

In accordance with an exemplary embodiment, a computer program product is provided. The computer program product includes a computer useable medium having computer readable code means embodied therein for causing a computer to enable an audio input of a device where the audio input is in a mute mode. The computer readable code means in the computer program product includes computer readable code means for causing a computer to detect at least one input on a user interface of the device, computer readable code means for causing a computer to enable the audio input of the device in response to the at least one input and computer readable code means for causing a computer to automatically disable the audio input of the device wherein disabling the audio input returns the audio input to the mute mode.

### BRIEF DESCRIPTION OF THE DRAWINGS

The foregoing aspects and other features of the present embodiments are explained in the following description, taken in connection with the accompanying drawings, wherein:

FIG. 1 is a schematic diagram of a communication device incorporating features of the disclosed embodiments;

FIG. 2 shows a communication device in accordance with an embodiment;

FIG. 3 shows the communication device of FIG. 2 in a closed configuration;

FIG. 4 illustrates a flow diagram of a method in accordance with an embodiment; and

FIG. 5 is a block diagram of one embodiment of a typical apparatus that may be used to practice the features of the disclosed embodiments.

### DETAILED DESCRIPTION OF THE EXEMPLARY EMBODIMENT(s)

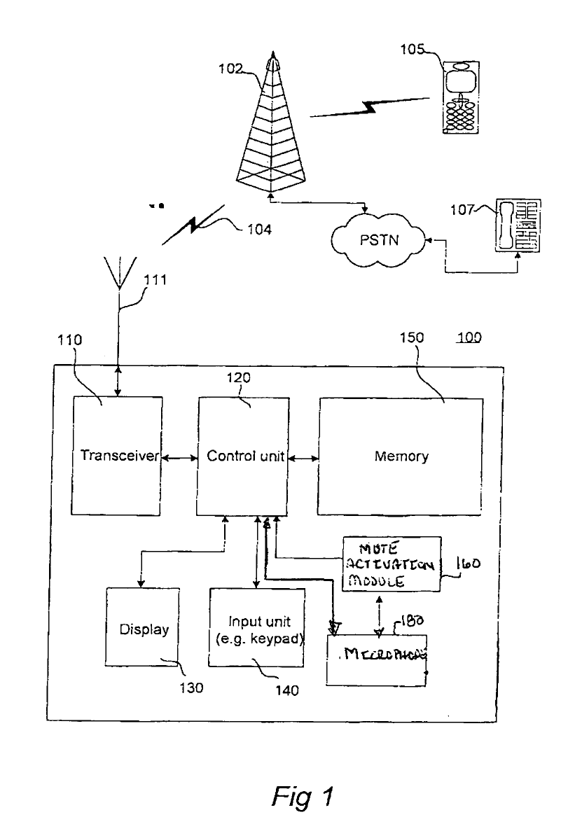

Referring to FIG. 1, one example of a device 100, such as a mobile communication device, incorporating features of the disclosed embodiments is shown. Although the present embodiments will be described with reference to the exemplary embodiments shown in the drawings and described below, it should be understood that the present embodiments could be embodied in many alternate forms of embodiments. In addition, any suitable size, shape or type of elements or materials could be used.

FIG. 1 is a schematic block diagram of a mobile telecommunication terminal 100 according to one embodiment. This system and the mobile communication terminal of FIG. 1 are used for ease of illustrating the disclosed embodiments and such illustrations are not intended to limit the aspects of the invention as claimed herein. A communication unit including a transceiver 110 is used for communicating with a base station 102 via an antenna 111. The base station 102 is in communication with other mobile telecommunication terminals 105 via a mobile communications network, and stationary terminals 107 via e.g. a public switched telephone network (PSTN).

Within communication device 100, a control unit 120 is coupled to the transceiver 110. The control unit 120 may comprise signal processing circuitry in order to process e.g. voice data and message data (e.g. SMS or MMS) from a user of the telecommunication terminal 100 and provide the transceiver 110 with the processed data for transmission to the base station 102. Likewise, the control unit 120 may comprise signal processing circuitry for processing data received from the other telecommunication terminals 105, 107 in order to provide the user of the mobile telecommunication terminal 100 with e.g. audio, image, video or message data. Alternatively (not shown) some or all of the signal processing functionality may be provided by specialized circuitry in the telecommunication terminal 100.

The control unit 120 is coupled to a main display 130 for providing a user of the telecommunication terminal 100 with visual data regarding e.g. a specific call in progress, telecommunication numbers stored in the mobile telecommunication terminal 100, signal strength of the wireless communication link 104, messages received from other telecommunication terminals, etc.

The control unit 120 is moreover coupled to an input unit 140, which may be in the form of a keyboard/keypad; an on-screen touch-sensitive keyboard; a navigation wheel or joystick for scrolling and selecting items, digits and/or characters shown on the display 130; and a microphone module 180 for receiving sound signals such as voice.

The control unit 120 can also be connected to a mute activation module 160, which can be used to control the mute/unmute functionality of the device 100 via the microphone module 180.

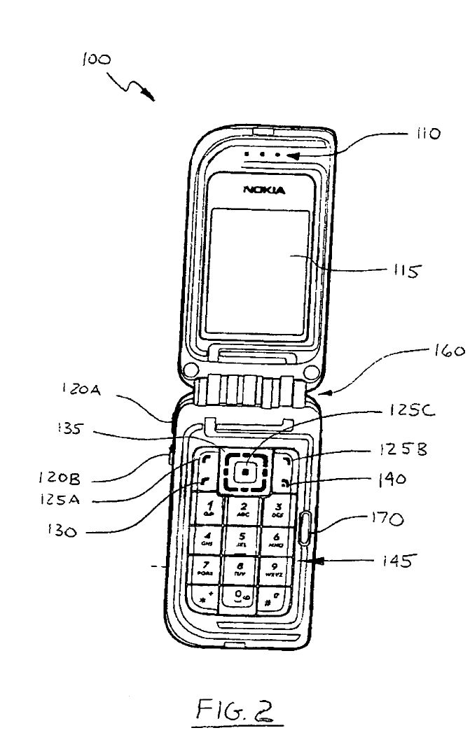

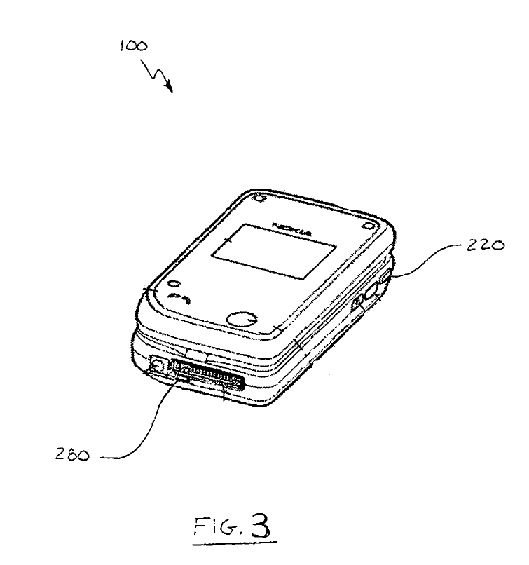

In one embodiment, the communication device 100 illustrated in FIG. 1 can comprise a mobile communication device, such as for example a mobile phone. In alternate embodiments, the device 100 can comprise any suitable communication device. Referring to FIGS. 2 and 3, an example of a communications device that can be used to practice aspects of the invention is shown. The device shown in FIGS. 2 and 3 is a mobile “flip” phone 100, which is shown in an open configuration. Although a flip phone will be used to describe the exemplary embodiments, the embodiments disclosed herein may be applied to any suitable mobile communication device. The mobile phone 100 may have a hinge 160 that allows the phone 100 to be folded into a closed position as can be seen in FIG. 2. The embodiments described herein may also be applied to land lines (i.e. phones connected to a wired communication network).

The mobile phone 100 may also include a main user interface having, for example, an earpiece or speaker 110 a main display screen 115, volume keys 120A, 120B, a left selection/soft key 125A, a right selection/soft key 125B, a middle selection key 125C, a four-way scroll key 135, a call key 130 an end key 140, a microphone 280 and a keypad 145. The main display screen 115 may be any suitable display such as a conventional display screen or a touch enabled screen. In alternate embodiments, the main user interface may have any suitable configuration. The main user interface may be, for example, the primary input of the mobile phone 100 and may be used for accessing all mobile phone functions.

A user of the mobile phone 100 may desire to make a call in a location where there is noticeable background noise such as for example, while in a car, on a train or at a restaurant. The user may also want to keep the listener or person on the other end of the phone call from hearing or being distracted by the background noise. The phone 100 may be equipped with a muting function so the user may disable the microphone 280 of the phone 100 thereby preventing the listener from hearing any undesirable sounds. In accordance with an exemplary embodiment, the mobile phone 100 may also include any suitable device for temporarily activating (i.e. unmuting) the microphone 280 of the phone 100 while the user is speaking into the phone 100.

The device for temporarily unmuting the microphone 280 may be, for example, a dedicated key such as key 170 located in a suitable area on the keypad 145 of the phone 100. The key 170 may be located so that it may be easily accessed while the user makes a phone call. In alternate embodiments, the key may be a user configurable key such as, for example, one of the selection/soft keys 125A, 125B such that when the user initiates a call the function of, for example, soft key 125A changes to an unmute feature of the phone 100. The unmute key 170 may also be a proximity switch that becomes active when, for example, a user places a finger over the switch. In other embodiments, the unmute feature of the phone 100 may, for example, be incorporated with the push-to-talk key 220. The push-to-talk key 220 may operate the phone in a manner similar to a hand held two way radio as is known in the art. However, when the user initiates a phone call over the cellular network, the function of the push-to-talk key 220 may automatically switch to operate the unmute feature of the phone. The unmute key may also take the form of a switch, a button, a dial or any other suitable user input that may be temporarily activated.

In operation, a user may set the microphone 280 of the phone 100 in a mute mode so that the microphone 280 is normally inoperable or disabled during a phone call so as to prevent a listener from hearing background noise at the user's location (FIG. 3, Block 300). The muting of the microphone 280 may be set in any suitable manner such as, for example, by making appropriate selections in a suitable settings menu of the phone 100. The settings menu may be accessed in any suitable manner such as through the main user interface of the phone 100.

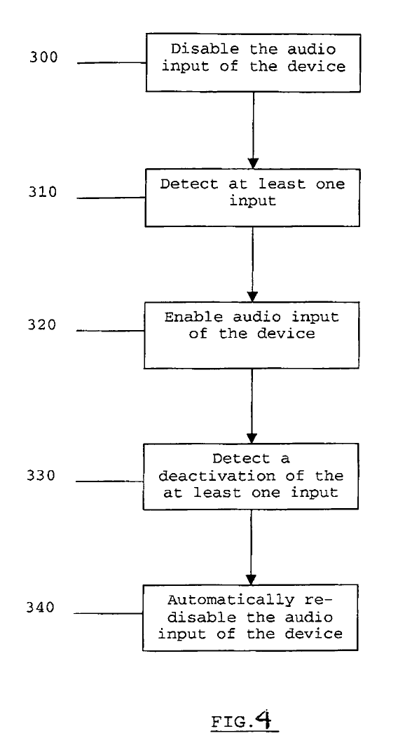

While on a call the user may press, for example, the unmute key 170 to temporarily enable the microphone 280 so that the listener or person on the other end of the phone conversation can hear the user. The muting module 160 of FIG. 1 may recognize when the unmute key 170 is pressed (FIG. 4, Block 310) and cause the microphone 280 to be temporarily enabled (FIG. 4, Block 320). The microphone 280 may remain enabled as long as the unmute key 170 is pressed. The muting module 160 may also recognize when the unmute key 170 is released or deactivated (FIG. 4, Block 330) and automatically disable the microphone 280 so that the microphone 280 is returned to the mute mode (FIG. 4, Block 340). Because the microphone 280 automatically returns to mute mode upon release of the unmute key 170, the unmute key 170 may eliminate the possibility of a user forgetting to return the phone 100 to a mute mode after speaking into the phone.

In another embodiment, the unmute feature may operate as a function of a user defined audio threshold. There may be an unmute settings feature in a menu of the mobile phone 100 that allows a user to set a sound level or activation threshold at which the microphone 280 becomes enabled. For example, if the background noise is at a noise level of sixty-five decibels, a user may set the unmute feature of the mobile phone to automatically enable the microphone 280 at a sound level of seventy decibels. The mobile phone 280 may also be equipped with a sound meter, such as, a decibel meter to aid the user in determining the activation threshold.

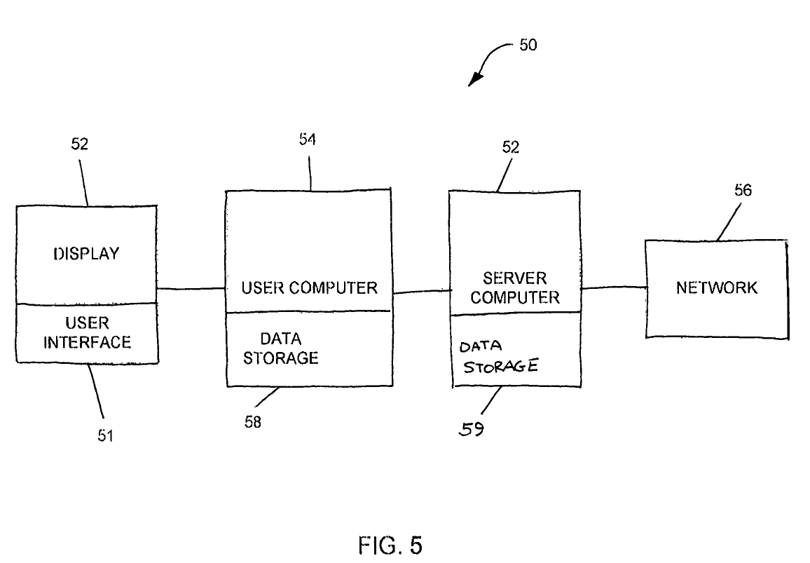

The disclosed embodiments may also include software and computer programs incorporating the process steps and instructions described above that are executed in different computers. FIG. 5 is a block diagram of one embodiment of a typical apparatus that may be used to practice the features of the disclosed embodiments. As shown, a computer system 50 may include a computer system 52 linked to another computer system 54, such that the computers 52 and 54 are capable of sending information to each other and receiving information from each other. In one embodiment, computer system 52 could include a server computer adapted to communicate with a network 56, such as for example, a telecommunications network. Computer systems 52 and 54 can be linked together in any conventional manner including a modem, hard wire connection, or fiber optic link. Generally, information can be made available to both computer systems 52 and 54 using a communication protocol typically sent over a communication channel or through a dial-up connection on ISDN line. Computers 52 and 54 are generally adapted to utilize program storage devices embodying machine readable program source code which is adapted to cause the computers 52 and 54 to carry out and perform the method steps of the disclosed embodiments. The program storage devices may be devised, made and used as a component of a machine utilizing optics, magnetic properties and/or electronics to perform the procedures and methods of the disclosed embodiments. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 52 and 54 may also include a microprocessor for executing stored programs. Computers 52 and 54 may include data storage devices 58, 59 on thier program storage device for the storage of information and data. The computer program or software incorporating the processes and method steps incorporating features of the disclosed embodiments may be stored in one or more computers 52 and 54 on an otherwise conventional program storage device. In one embodiment, computer 54, which can comprise the device 100 of FIG. 1, may include a user interface 51, and a display interface 52 from which features of the invention can be accessed. The user interface 51 and the display interface 52 can be adapted to allow the input of queries and commands to the computer 54, as well as present the results of the commands and queries.

The disclosed embodiments allow a user to place a communications device into a “mute” mode. When a key on the device is pressed or activated, the “mute” function is disabled. When the key is released, the device goes back into the mute mode. In this fashion, the user does not forget to put the device back into a mute mode since it occurs automatically.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
an audio input module; and
an activation device configured to activate the audio input module when the audio input module is in a mute mode.

2. The apparatus of claim 1, wherein the apparatus comprises a mobile telephone.

3. The apparatus of claim 1, wherein the activation device is a combination of one or more keys on a user interface of the apparatus.

4. The apparatus of claim 1, wherein the audio input module is an internal or external microphone of the apparatus.

5. The apparatus of claim 1, wherein the audio input module is configured to return to the mute mode upon a deactivation of the activation device.

6. The apparatus of claim 1, wherein the activation device is located on a side of the mobile device.

7. The apparatus of claim 1, wherein the activation device is a function of user defined audio threshold.

8. A method comprising:
disabling an audio input of a device;
detecting at least one input on a user interface of the device;
enabling the audio input of the device in response to the at least one input;
detecting a deactivation of the at least one input; and
automatically re-disabling the audio input of the device.

9. The method of claim 8, wherein the device is a mobile telephone.

10. The method of claim 8, wherein detecting at least one input comprises detecting the activation of one or more keys on a user interface of the device.

11. The method of claim 8, wherein enabling the audio input comprises pressing at least one key on the device and disabling the audio input comprises releasing the at least one key.

12. The method of claim 8, further comprising automatically changing a function of a push-to-talk key of the device to a function for enabling an audio input of the device upon placing a phone call within a cellular network.

13. The method of claim 12, wherein pressing the push-to-talk key enables the audio input and releasing the push-to-talk key automatically disables the audio input.

14. A computer program product comprising:
a computer useable medium having computer readable code means embodied therein for causing a computer to enable an audio input of a device where the audio input is in a mute mode, the computer readable code means in the computer program product comprising:
computer readable code means for causing a computer to detect at least one input on a user interface of the device;
computer readable code means for causing a computer to enable an audio input of the device in response to the at least one input; and
computer readable code means for causing a computer to automatically disable the audio input of the device wherein disabling the audio input returns the audio input to the mute mode.

15. The computer program product of claim 14, wherein the computer readable code means in the computer program product further comprises, computer readable code means for causing the enabling of the audio input in response to a user pressing at least one key on the device and causing the audio input to return to the mute mode in response to the releasing of the at least one key.

16. The computer program product of claim 14, wherein the computer readable code means in the computer program product further comprises, computer readable code means for causing a function of a push-to-talk key of the device to automatically change to a function for enabling an audio input of the device upon placing a phone call within a cellular network.
